(19) United States
(12) Patent Application Publication
(10) Pub. No.: US 2007/0167321 A1
(43) Pub. Date: Jul. 19, 2007

(54) Method for recovering molybdenum and method for preparing catalyst

(75) Inventors: Tomomasa Tatsumi, Hiroshima (JP); Hiroyuki Naitou, Hiroshima (JP); Toru Kuroda, Hiroshima (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Raycon Co., Ltd., Tokyo (JP)

(21) Appl. No.: 10/590,291

(22) PCT Filed: Feb. 18, 2005
(86) PCT No.: PCT/JP05/02593

§ 371 Date: Aug. 23, 2006

(30) Foreign Application Priority Data
Feb. 24, 2004 (JP) 2004-047935
Aug. 11, 2004 (JP) 2004-234723

(51) Int. Cl. C01G 41/00

(52) U.S. Cl. 502/321; 423/55

(57) ABSTRACT

A method for obtaining a material containing recovered molybdenum for use in producing a catalyst from a molybdenum-containing material comprising at least molybdenum, A element (phosphorus and/or arsenic) and X element (at least one selected from the group consisting of potassium, rubidium, cesium and thallium), in particular, from a spent catalyst; and a method for producing a catalyst using said material containing recovered molybdenum. A particularly preferred catalyst is a catalyst for use in producing methacrylic acid through gas-phase catalytic oxidation.

### TECHNICAL FIELD

The present invention relates to a method for recovering solution containing at least molybdenum (recovered molybdenum-containing liquid) or precipitate containing at least molybdenum (recovered molybdenum-containing precipitate) from a molybdenum-containing material comprising at least molybdenum, A element (phosphorus and/or arsenic) and X element (at least one selected from the group consisting of potassium, rubidium, cesium and thallium), and a method for producing a catalyst using the recovered molybdenum-containing liquid and/or the recovered molybdenum-containing precipitate.

### BACKGROUND ART

The molybdenum-containing material comprising at least molybdenum, A element (phosphorus and/or arsenic) and X element (at least one selected from the group consisting of potassium, rubidium, cesium and thallium) is widely known for its effectiveness as a heteropolyacid based catalyst which is used in producing, for example, methacrylic acid through oxidative dehydrogenation of isobutyric acid or methacrylic acid through gas-phase oxidation of methacrolein. It is also used in a process for producing methacrylic acid through direct gas-phase oxidation of isobutylene.

Generally, in an industrial gas-phase oxidation reaction, a catalyst is used for a certain period of time and after being used for the period of time, the catalyst is taken out from a reactor and replaced by a new one. The spent catalyst thus taken out from the reactor contains many useful elements as raw materials for producing a catalyst, such as molybdenum, potassium, rubidium and cesium. It is a very important subject from the economical point of view and from the viewpoint of reducing the load to environment to develop the technology for recovering and reusing these elements or recycling and reusing the spent catalyst.

As a method for recovering catalyst components from a spent catalyst, a method is known, which comprises the step of thermally decomposing a heteropolyacid salt based spent catalyst with sodium hydroxide followed by contacting the resultant mixture with sodium type strongly acidic resin to selectively adsorb and separate cesium, rubidium and thallium or potassium, eluting the adsorbed elements with sulfuric acid and recovering these elements as sulfates of each element, and the step of recovering a heteropolyacid by treating the solution of the sodium salt of the heteropolyacid separated in the foregoing step with proton type strongly acidic ion-exchange resin (refer to, for example, JPH07-213,922-A1 (Patent document 1)).

Further, as a method for regenerating a catalyst, a regenerating method of treating a spent catalyst used in producing methacrylic acid with hydrochloric acid (refer to, for example, JPS54-002,293-A1 (Patent document 2)), a regenerating method of treating the spent catalyst with a nitrogen-containing heterocyclic compound (refer to, for example, JPS60-232,247-A1 (Patent document 3)), a regenerating method of adding ammonium species and nitrate species to a deactivated catalyst (refer to, for example, JPS61-283,352-A1 (Patent document 4)), a regenerating method of treating the spent catalyst with inorganic ion exchanger such as crystalline antimonate (refer to, for example, JPH06-285,373-A1 (Patent document 5)) and the like are known.

However, the recovering method disclosed in JPH07-213,922-A1 (Patent document 1) uses ion-exchange resin in two steps. In a recovering method using ion-exchange resin, it is necessary to lower the concentration of the element to be recovered in the solution to be treated for recovering. Consequently, it causes the problem that using ion-exchange resin in the two steps as in the above case results in increase in the area of equipment and the used amount of the ion-exchange resin, and hence, it is not economical.

Further, as the regenerating methods disclosed in JPS54-002,293-A1 (Patent document 2), JPS60-232,247-A1 (Patent document 3), JPS61-283,352-A1 (Patent document 4) and JPH06-285,373-A1 (Patent document 5), there is a problem that a catalyst can be regenerated to a certain level but its yield of methacrylic acid using the regenerated catalyst is lower than that using a catalyst produced in a ordinary method.

As a method which has solved these problems, there is a method in which a recovered spent catalyst is dispersed in water, and to the resultant dispersion, an alkali metal compound and aqueous ammonia are added, and then pH of the mixed liquid is adjusted to 6.5 or less to precipitate molybdenum together with phosphorus and arsenic and to recover them as a molybdenum-containing precipitate which is usable in producing a catalyst (refer to, for example, U.S. Pat. No. 6,777,369 (Patent document 6)).

However, the molybdenum-containing precipitate obtained by the method disclosed in U.S. Pat. No. 6,777,369 (Patent document 6) also contains phosphorus and arsenic which have been originally included in the raw material for recovering, and there is a restriction on using this precipitate directly for producing a new catalyst.

Patent document 1: JPH07-213,922-A1

Patent document 2: JPS54-002,293-A1

Patent document 3: JPS60-232,247-A1

Patent document 4: JPS61-283,352-A1

Patent document 5: JPH06-285,373-A1

Patent document 6: U.S. Pat. No. 6,777,369

### DISCLOSURE OF INVENTION

### Problem to be Solved by the Invention

Therefore, the problems of the present invention are to provide a method for recovering solution containing at least molybdenum (recovered molybdenum-containing liquid) or precipitate containing at least molybdenum (recovered molybdenum-containing precipitate), which can be used in producing a catalyst as well as fresh molybdenum compounds, from a molybdenum-containing material comprising at least molybdenum, A element (phosphorus and/or arsenic) and X element (at least one selected from the group consisting of potassium, rubidium, cesium and thallium), in particular, from a recovered spent catalyst, and to provide a method for producing a catalyst using the recovered molybdenum-containing liquid or the recovered molybdenum-containing precipitate as a raw material of the catalyst.

### MEANS FOR SOLVING PROBLEM

To solve the problems described above, the present inventors have intensively researched and have found that by dispersing a molybdenum-containing material which is a raw material for recovering molybdenum in an alkaline solution, and then by making a magnesium-containing compound act on the dispersion at a specified range of pH, it is possible to recover molybdenum in a state which can be used in producing various kinds of catalysts containing molybdenum and thus have completed the present invention.

Namely, the present invention resides in a method for recovering molybdenum comprising the steps of:

1) dispersing a molybdenum-containing material which contains at least molybdenum, A element (phosphorus and/or arsenic) and X element (at least one selected from the group consisting of potassium, rubidium, cesium and thallium) in water and adding alkali to make pH of the resultant mixed liquid 8 or more;

2) adjusting pH of the resultant mixed liquid to fall within the range of from 6 to 12 followed by adding a compound containing magnesium and aqueous ammonia to form a precipitate containing at least magnesium and A element; and

3) separating the precipitate containing at least magnesium and A element formed in the step 2) from a solution containing at least molybdenum (recovered molybdenum-containing liquid).

Moreover, the present invention resides in the above-mentioned method for recovering molybdenum, further comprising the step of:

4) forming a precipitate containing at least molybdenum by adjusting the pH of the recovered molybdenum-containing liquid to 3 or less with an addition of acid and separating the precipitate thus formed (recovered molybdenum-containing precipitate) from the solution.

Further, the present invention resides in a method for producing a catalyst by using a recovered molybdenum-containing liquid a recovered molybdenum-containing precipitate which has been recovered by the above-mentioned methods for recovering molybdenum.

### EFFECT OF THE INVENTION

According to the present invention, useful molybdenum can be recovered in the form of reusable solution or precipitate by an easy operation from a molybdenum-containing material which contains at least molybdenum, A element (phosphorus and/or arsenic) and X element (at least one selected from the group consisting of potassium, rubidium, cesium and thallium), in particular, from a molybdenum-containing spent catalyst.

Further, when the recovered molybdenum-containing liquid or precipitate produced in the present invention is used in producing a catalyst, it is possible not only that a molybdenum-containing spent catalyst can be used effectively, but also that a catalyst with the same yield of methacrylic acid can be obtained as in the case where a conventional raw material of molybdenum is used and the recovered molybdenum-containing material is not used. Moreover, it is advantageous that there is little limitation on a method for producing a catalyst because these solutions or precipitates do not practically contain A element (phosphorus and/or arsenic).

### BEST MODE FOR CARRYING OUT THE INVENTION

In the present invention, a molybdenum-containing material to be used in recovering molybdenum comprises at least molybdenum, A element and X element and, for example, a spent catalyst used in a reaction for producing methacrylic acid through gas-phase catalytic oxidation of methacrolein or in a reaction for producing methacrylic acid through oxidative dehydrogenation of isobutylic acid can be mentioned. In the case of these catalysts for producing methacrylic acid, those having a composition represented by the following formula (1) are preferable, and those having a composition represented by the following formula (2) are particularly preferable.
AₐMo_{b}Y_{c}X_{d}Oₑ (1)

Wherein, Mo and O represent molybdenum and oxygen, respectively; A represents phosphorus and/or arsenic; Y represents at least one element selected from the group consisting of iron, cobalt, nickel, copper, zinc, magnesium, calcium, strontium, barium, titanium, vanadium, chromium, tungsten, manganese, silver, boron, silicon, aluminum, gallium, germanium, tin, lead, antimony, bismuth, niobium, tantalum, zirconium, indium, sulfur, selenium, tellurium, lanthanum and cerium; X represents at least one element selected from the group consisting of potassium, rubidium, cesium and thallium; and subscripts a, b, c, d and e represent an atomic ratio of each element, respectively; when b is 12, a is in the range of from 0.1 to 3, c is in the range of from 0 to 3 and d is in the range of from 0.01 to 3 and e represents the atomic ratio of oxygen necessary for fulfilling the requirement of the valence of each element above.
AₐMo_{b}Y′_{c′}Cu_{f}V_{g}X_{d}Oₑ (2)

In the formula, Mo, Cu, V and O represent molybdenum, copper, vanadium and oxygen, respectively; A represents phosphorus and/or arsenic; Y′ represents at least one element selected from the group consisting of iron, cobalt, nickel, zinc, magnesium, calcium, strontium, barium, titanium, chromium, tungsten, manganese, silver, boron, silicon, aluminum, gallium, germanium, tin, lead, antimony, bismuth, niobium, tantalum, zirconium, indium, sulfur, selenium, tellurium, lanthanum and cerium, preferably selected from iron, zinc, germanium, antimony, lanthanum and cerium; X represents at least one element selected from the group consisting of potassium, rubidium, cesium and thallium, preferably selected from potassium, rubidium and cesium; and subscripts a, b, c′, f, g, d and e represent an atomic ratio of each element, respectively; when b is 12, a is in the range of from 0.1 to 3, preferably from 0.5 to 3, c′ is in the range of from 0 to 2.98, preferably from 0 to 2.5, f is in the range of from 0.01 to 2.99, preferably from 0.01 to 2, g is in the range of from 0.01 to 2.99, preferably from 0.01 to 2 and d is in the range of from 0.01 to 3, preferably from 0.1 to 3 and e represents the atomic ratio of oxygen necessary for fulfilling the requirement of the valence of each element above, and besides, (c′+f+g) is in the range of from 0.02 to 3.

Further, a catalyst from which molybdenum is recovered is not particularly limited and a spent catalyst used in a reaction for producing methacrylic acid is usually used, and a catalyst which has been stopped to use for certain reasons, a catalyst which has been drawn from a reactor in the middle of its use in a reaction and the like are also usable.

(Step 1)

A molybdenum-containing material which contains at least molybdenum, A element and X element is dispersed in water first, and then alkali is added to it. Amount of alkali to be added is such that pH of the resultant dispersion becomes 8 or more, preferably from 8.5 to 13. A kind of alkali to be used is not particularly limited and, for example, sodium hydroxide, potassium hydroxide, cesium hydroxide, sodium carbonate and aqueous ammonia can be mentioned, and in particular, sodium hydroxide is preferable. Further, when a catalyst is totally or partially in a reduced state, it is preferable to oxidize it by calcinations in air, chlorination, hydrogen peroxide treatment or the like before the alkali addition, or by chlorination, hydrogen peroxide treatment or the like after the alkali addition.

(Step 2)

Then, the resultant liquid of molybdenum-containing material is previously adjusted for its pH to fall within the range of from 6 to 12, and to the resultant liquid, a compound containing magnesium and aqueous ammonia are added. Then, the resultant liquid is adjusted again for its pH to fall within the range of from 6 to 12 if needed, and a precipitate containing at least magnesium and A element is formed. It is preferable to remove insoluble materials by filtration or the like from the solution existing before the compound containing magnesium and aqueous ammonia are added. Amount of addition of the compound containing magnesium and ammonia when the precipitate is formed is preferably one mol or more of each component per one mol of A element.

The compound containing magnesium to be used when the precipitate is formed is not particularly limited and magnesium chloride, magnesium sulfate, magnesium nitrate or the like can be used.

Further, pH of the liquid in the step 2 is from 6 to 12, preferably from 6.5 to 11, more preferably from 7 to 10. When the pH of the liquid is less than 6, a precipitate is not formed or insufficient if formed so that an uptake of A element into the precipitate becomes insufficient as well as a rate of recovery of molybdenum becomes low because ammonium dodecamolybdophosphate is liable to precipitate, and hence, it is not preferable. On the other hand, when the pH of the liquid is more than 12, magnesium becomes magnesium hydroxide, and hence, an uptake of A element becomes insufficient.

The compound to be used in adjusting pH of those liquids is not particularly limited and, for example, hydrochloric acid, sulfuric acid, nitric acid, acetic acid, ammonia, sodium hydroxide, potassium hydroxide or the like can be mentioned, and among them, hydrochloric acid and ammonia are preferable.

It is preferable to hold the liquid for a certain period of time after adding the compound containing magnesium and aqueous ammonia to form a precipitate. At this time, the holding time is preferably around from 0.5 to 24 hours, and temperature of the liquid is preferably around from room temperature to 90° C. While holding the liquid, it may be stood still, but preferably it is stirred.

(Step 3)

The precipitate containing at least magnesium and A element formed in the above-mentioned precipitate forming step is separated from a solution containing at least molybdenum (recovered molybdenum-containing liquid). A method for separating the precipitate from the solution is not particularly limited and general methods such as filtration separation method including gravity filtration, filtration under pressure, filtration under reduced pressure, filter press and the like or centrifugal separation method can be applied.

(Step 4)

The solution containing at least molybdenum (recovered molybdenum-containing liquid) obtained by separating the precipitate containing magnesium and A element can be used by itself as a raw material of molybdenum in the production of a catalyst, however, it is preferable to subsequently adjust pH of the solution to form a precipitate containing at least molybdenum (recovered molybdenum-containing precipitate).

At the time of forming the recovered molybdenum-containing precipitate, pH of the solution is preferably 3 or less, particularly preferably 2 or less. A compound to be used for adjusting pH of the solution is not particularly limited and, for example, strong acids such as hydrochloric acid, nitric acid and sulfuric acid can be mentioned, and among them, nitric acid or hydrochloric acid is preferable. After adjusting pH of the solution, it is preferable to hold the resultant solution for a certain period of time to form a precipitate. At this time, the holding time is preferably around from 0.5 to 24 hours, and temperature of the solution is preferably around from room temperature to 90° C. While holding the solution, it may be stood still, but preferably it is stirred.

A method for separating the recovered molybdenum-containing precipitate from its bottom is not particularly limited and general methods such as filtration separation method including gravity filtration, filtration under pressure, filtration under reduced pressure and filter press or centrifugal separation method can be used. Further, the recovered molybdenum-containing precipitate may be washed to remove its impurities if necessary. In this case, the washing liquid is selected in view of use or solubility of the recovered molybdenum-containing precipitate and, for example, pure water, dilute aqueous solution of ammonium nitrate or ammonium chloride can be mentioned. As the recovered molybdenum-containing precipitate after washed, each amount of sodium and chlorine contained in the precipitate is preferably 0.1 mole or less per 12 moles of molybdenum, more preferably 0.05 mole or less.

When the recovered molybdenum-containing precipitate is formed from the recovered molybdenum-containing liquid, the liquid may contain vanadium in some cases depending on a molybdenum-containing material which is a raw material for recovering. When the liquid or precipitate is used as a raw material for producing a catalyst, it is preferable to partially or totally remove vanadium from the solution depending on a composition of the catalyst to be produced. A method for removing vanadium from the liquid is not particularly limited and, for example, a method in which pH of the recovered molybdenum-containing liquid including vanadium other than molybdenum is adjusted first and vanadium is removed from the resultant liquid by adsorption with a weak basic anion-exchange resin or a method of precipitation separation by using ammonium chloride or ammonium sulfate can be mentioned. Time of removing vanadium is not particularly limited as long as it is located, after separating the precipitate containing magnesium and A element and before forming the recovered molybdenum-containing precipitate.

In the present invention, the recovered molybdenum-containing liquid and/or the recovered molybdenum-containing precipitate thus obtained can be used as a raw material for producing a catalyst. Hereinafter, the recovered molybdenum-containing liquid and the recovered molybdenum-containing precipitate are also expressed altogether as “recovered molybdenum-containing material”. A state of the recovered molybdenum-containing material to be used in the production of catalyst is not particularly limited and any one of a solution state, a wet state or a dry state may be chosen. Further, when a state of oxide is desired to be used as a raw material of a catalyst, an oxide obtained by calcining these recovered molybdenum-containing materials, in particular, the recovered molybdenum-containing precipitate can be used. Calcining condition is preferably from 300 to 600° C. under an atmosphere of oxygen-containing gas such as air, for 0.5 hour or more.

(Production of Catalyst)

In the present invention, a method for producing a catalyst is not particularly limited and can be properly chosen from various methods such as coprecipitation, evaporation to dryness or mixing of oxides in accordance with a state of the recovered molybdenum-containing material which is used as a raw material.

Further, in the method for producing a catalyst, the recovered molybdenum-containing material and/or its calcined material may be used alone, or if necessary, together with the other raw materials of molybdenum such as those which are recovered by a method other than the above-mentioned recovering method or produced from molybdenum ore (hereinafter, these are also expressed as “the other raw materials of molybdenum”). A method for producing a raw material of molybdenum other than the above-mentioned recovered molybdenum-containing material is not particularly limited and, for example, a method in which ammonium paramolybdate is obtained through calcining molybdenum ore, washing the resultant crude molybdenum trioxide with nitric acid followed by dissolving it with aqueous ammonia, refining the resultant solution, adjusting pH of the solution by nitric acid to obtain molybdic acid, dissolving again the molybdic acid with aqueous ammonia followed by concentration and crystallization or a method in which molybdenum trioxide is obtained through calcination of ammonium paramolybdate or molybdic acid can be mentioned. Moreover, a raw material other than the recovered molybdenum-containing material to be used in preparing a catalyst is not particularly limited and nitrates, carbonates, acetates, ammonium salts, oxides, halides or oxyacids of each element can be used in combination. For example, as a raw material of molybdenum, ammonium paramolybdate, molybdenum trioxide, molybdic acid, molybdenum chloride and the like can be used and as a raw material of phosphorus, phosphoric acid, phosphorus pentoxide, ammonium phosphate and the like can be used.

As a practical method for preparing a catalyst, for example, a method in which a dried material of a slurry containing at least A element and X element together with the recovered molybdenum-containing material and the other raw materials of molybdenum mentioned above which is used if necessary are calcined or a method in which a dried mixture containing at least A element and X element together with the recovered molybdenum-containing material and the other raw materials of molybdenum mentioned above which is used if necessary are calcined can be mentioned. Further, in a method for producing a catalyst, when amounts of addition of raw materials containing elements of the catalyst components are adjusted in view of the amount of the impurities originating from the elements which are included in the recovered molybdenum-containing material to be used as a raw material, a supplemental amount of raw materials equivalent to shortage of counter ions contained in the raw materials may be added. For example, when an amount of addition of vanadium is adjusted by reducing the amount of addition of ammonium metavanadate, shortage of ammonium ion can be adjusted by supplemental addition of aqueous ammonia or when an amount of addition of potassium or cesium is adjusted by reducing the amount of addition of potassium nitrate or cesium nitrate, shortage of nitrate ion can be adjusted by supplemental addition of nitric acid.

In the present invention, it is preferable that ammonia is mixed when a catalyst is produced. A source of ammonia is not particularly limited and ammonia itself or its aqueous solution or ammonium salts of various acids may be used. Further, ammonia may be mixed as ammonium salts of molybdic acid or phosphoric acid. Amount of ammonia to be used is preferably 1 to 17 moles per 12 moles of molybdenum, particularly preferably 2 to 13 moles. As an ammonium salt, ammonium carbonate, ammonium hydrogencarbonate or ammonium nitrate can be mentioned. These salts may be used alone or in combination of two or more kinds and not particularly limited.

In the present invention, a method for mixing ammonia is not particularly limited and, for example, a method in which aqueous ammonia is added after dispersing the recovered molybdenum-containing material in water or a method in which aqueous ammonia or ammonium nitrate is added after heating and stirring a liquid containing at least the recovered molybdenum-containing material, A element and X element under refluxing and cooling to a fixed temperature can be mentioned. Further, ammonia to be mixed may be the one contained in the recovered molybdenum-containing material. Using various raw materials containing ammonia component to be normally used in producing a catalyst can serve as an ammonia addition.

Further, in the production of a catalyst of the present invention, when a step in the production proceeds via a state of solution or slurry, temperature of the solution or slurry may be the same as that in a normal method for producing a catalyst, in which the recovered molybdenum-containing material of the present invention is not used, but can be lower than that in the normal method in a part of the steps or in the entire steps. In that case, it is preferable to properly determine the temperature of the solution or slurry in view of a particle size distribution of the precipitated particles in the slurry, moldability of the obtained powder, pore size distribution of the catalyst or reaction performance of the catalyst, and the temperature is preferably 0 to 40° C., more preferably 0 to 30° C. lower than that in the normal method.

Further, a method for drying slurry is not particularly limited and a method using a box type dryer, a spray dryer, a drum dryer or the like is usable. In this case, the resultant dried material (catalyst precursor) is preferably powder in view of the subsequent molding. The dried material may be molded directly or after calcined. A method for molding is not particularly limited either and, for example, tablet molding, extrusion molding, granulation, supporting on carrier or the like can be mentioned. As a carrier of supported catalyst, for example, inert carriers such as silica, alumina, silica-alumina and silicon carbide can be mentioned. When molding is carried out, additives, for example, inorganic salts such as barium sulfate and ammonium nitrate, lubricants such as graphite, organic materials such as cellulose, starch, polyvinyl alcohol and stearic acid, hydroxide sols such as silica sol and alumina sol, inorganic fibers such as whisker, glass fiber and carbon fiber, or the like may be properly added with a view to controlling specific surface area, pore volume and pore-size distribution and improving mechanical strength of the molded articles.

When a molded article is calcined, calcinations may be carried out either before the molded article being packed in a reactor or in the reactor in which the molded article has been packed. Calcining conditions can not be exactly said because they are variant depending on raw materials of a catalyst to be used, a catalyst composition, a preparing condition and the like. However, they are preferably from 300 to 500° C., more preferably from 300 to 450° C., under a flow of oxygen-containing gas such as air and/or inert gas, for 0.5 hour or more, more preferably from 1 to 40 hours.

(Production of Methacrylic Acid)

Hereinafter, a reaction condition in the case of producing methacrylic acid through gas-phase catalytic oxidation of methacrolein is explained.

A reaction condition in the case that a reaction is carried out by using a catalyst produced by the method of the present invention is not particularly limited and a publicly known reaction condition can be applied.

In the gas-phase catalytic oxidation reaction, feed gas containing at least methacrolein and molecular oxygen is contacted with a catalyst. Normally, a tubular reactor packed with a catalyst is used for reaction. Industrially, a multitubular reactor equipped with a lot of reaction tubes is used.

Concentration of methacrolein in the feed gas can be changed in a wide range; however, it is preferably from 1 to 20% by volume, particularly preferably from 3 to 10% by volume. In raw methacrolein, impurities such as water and lower saturated aldehyde, which do not substantially exert influence on the reaction, are included in some cases, but those impurities originating from methacrolein are allowable.

Molecular oxygen needs to be contained in the feed gas and the amount of molecular oxygen in the feed gas is preferably 0.4 to 4 times in moles as much as the amount of methacrolein, particularly preferably 0.5 to 3 times in moles. As a source of molecular oxygen in the feed gas, it is industrially profitable to use air, but oxygen-enriched air by pure oxygen can also be used, if necessary. Further, it is preferable that the feed gas is diluted with inert gas such as nitrogen and carbon dioxide or water vapor.

Reaction pressure of the gas-phase catalytic oxidation is from normal pressure to several atmospheric pressure. Reaction temperature is preferably 200 to 450° C., more preferably 250 to 400° C. Contact time of the feed gas with the catalyst is preferably 1.5 to 15 seconds, more preferably 2 to 7 seconds.

### EXAMPLES

Next, the present invention is explained by using examples. In these examples, “part(s)” means part(s) by mass. Further, quantitative analysis of elements (or molecules) contained in a material was carried out by ICP emission analysis or atomic absorption analysis. The analysis of the feed gas and products in the production of methacrylic acid was carried out by gas chromatography.

A ratio of recovery of each element, conversion of methacrolein which is a raw material, selectivity to methacrylic acid produced and yield of methacrylic acid are defined as follows:

a) Ratio of recovery of each element:
Ratio of recovery (% by mass)=(Wr/Ws)×100

Wherein Wr represents the amount by mass of an element contained in an obtained composition and Ws represents the amount by mass of an element contained in a composition used for recovery.

b) Conversion of methacrolein which is a raw material, selectivity to methacrylic acid produced and per pass yield of methacrylic acid:
Conversion of methacrolein (mol %)=(B/A)×100
Selectivity to methacrylic acid (mol %)=(C/B)×100
Per pass yield of methacrylic acid (mol %)=(C/A)×100

Wherein A represents mole number of methacrolein supplied; B represents mole number of methacrolein reacted; and C represents mole number of methacrylic acid produced.

### Reference Example 1

(Production of Catalyst A for Use in Producing Methacrylic Acid)

In 300 parts of pure water, 100 parts of ammonium paramolybdate, 4.4 parts of ammonium metavandate and 9.2 parts of cesium nitrate were dissolved at 70° C. To the resultant solution, a solution obtained by dissolving 8.7 parts of 85 mass % phosphoric acid in 10 parts of pure water was added and then 5.5 parts of antimony trioxide was added and heated to 95° C. with stirring, and a solution obtained by dissolving 1.1 parts of copper nitrate in 10 parts of pure water was added. Further, the resultant mixed liquid was stirred for 15 minutes at 95° C. and evaporated to dryness with stirring under heating. The solid material thus obtained was dried for 16 hours at 130° C., and then pressure molded, and further, crushed, and particles which were passed through a 1.70 mm-mesh opening sieve and kept on a 0.85 mm-mesh opening sieve were fractionated, and the resultant particles were heat treated at 380° C. for 5 hours under a flow of air to obtain catalyst A (the composition exclusive of oxygen: P_{1.6}Mo₁₂Sb_{0.8}Cu_{0.1}V_{0.8}Cs₁).

(Test A of the Production of Methacrylic Acid)

The catalyst A was packed in a reactor and a mixed gas containing 5% by volume of methacrolein, 10% by volume of oxygen, 30% by volume of water vapor and 55% by volume of nitrogen was passed through it at a reaction temperature of 290° C. and contact time of 3.6 seconds. As a result, conversion of methacrolein was 82.9 mol %, selectivity to methacrylic acid was 83.7 mol % and per pass yield of methacrylic acid was 69.3 mol %.

### Example 1

(Recovery of Molybdenum 1)

A catalyst was produced in the same manner as in the production of catalyst A for use in producing methacrylic acid of Reference Example 1 (the composition exclusive of oxygen of the catalyst: P_{1.6}Mo₁₂Cs₁) and by using this catalyst, the test A of the production of methacrylic acid was carried out for 2,000 hours and the spent catalyst was recovered. In 100 parts of the recovered catalyst, 56.3 parts of molybdenum, 2.4 parts of phosphorus and 6.5 parts of cesium were contained. To 400 parts of pure water, 100 parts of the recovered catalyst was dispersed. To the resultant dispersion, 130 parts of 45 mass % sodium hydroxide aqueous solution was added and stirred for 3 hours at 60° C. The pH of the resultant solution was 12.3. The solution was neutralized to pH 7 by 36 mass % hydrochloric acid, and a solution obtained by dissolving 20.5 parts of magnesium chloride hexahydrate in 50 parts of pure water and 4.5 parts of 29 mass % aqueous ammonia were added, and further, the pH of the resultant solution was adjusted to 9 by adding 29 mass % aqueous ammonia, and kept at 30° C. for 3 hours with stirring, and precipitates were thus formed and the bottom liquid (recovered molybdenum-containing liquid) were separated by filtration. The pH of the recovered molybdenum-containing liquid thus obtained was adjusted to 1.0 by adding 36 mass % hydrochloric acid and the resultant solution was kept at 30° C. for 3 hours with stirring. The precipitate thus obtained was filtrated and washed by 2 mass % ammonium nitrate solution to obtain “recovered molybdenum-containing material 1”. The recovered molybdenum-containing material 1 contained 55.5 parts of molybdenum and 2.9 parts of cesium. And, at this time, ratio of recovery of molybdenum was 98.6% by mass. Furthermore, phosphorus was not detected in the recovered molybdenum-containing material 1.

(Production of Catalyst 1)

The total amount of the recovered molybdenum-containing material 1 obtained above (55.5 parts as molybdenum) was dispersed in 280 parts of pure water and 29.1 parts of 29 mass % aqueous ammonia was added to it and the material was dissolved at 60° C. In the resultant solution, 4.5 parts of ammonium metavanadate and 5.2 parts of cesium nitrate were dissolved. Then, a solution obtained by dissolving 8.9 parts of 85 mass % phosphoric acid in 10 parts of pure water was added, and further, 5.6 parts of antimony trioxide was added and the resultant solution was heated to 95° C. with stirring, and a solution obtained by dissolving 1.2 parts of copper nitrate in 10 parts of pure water was added. The amount of ammonia in the resultant solution was 11.1 moles per 12 moles of molybdenum. Further, the mixed liquid was stirred for 15 minutes at 95° C., and then, evaporated to dryness with stirring under heating. The solid material thus obtained was dried, molded, crushed, fractionated by sieves and calcined in the same manner as in the production of catalyst A for use in producing methacrylic acid of Reference Example 1 to obtain catalyst 1. The composition exclusive of oxygen of the catalyst 1 was P_{1.6}Mo₁₂Sb_{0.8}Cu_{0.1}V_{0.8}Cs₁ which was the same as the catalyst A produced in Reference Example 1.

(Test 1 of the Production of Methacrylic Acid)

By using this catalyst 1, reaction was carried out in the same reaction condition as that in the test A of the production of methacrylic acid and obtained the following results. Conversion of methacrolein was 83.0 mol %, selectivity to methacrylic acid was 83.5 mol % and per pass yield of methacrylic acid was 69.3 mol %, and the catalyst 1 had the same performance as the catalyst A.

### Example 2

(Recovery of Molybdenum 2)

In 100 parts of the spent catalyst which had been used in the reaction for 2,000 hours in the test 1 of the production of methacrylic acid of Example 1, 55.1 parts of molybdenum, 2.4 parts of phosphorus, 4.5 parts of antimony, 0.3 part of copper, 2.0 parts of vanadium and 6.4 parts of cesium were contained. The elemental composition exclusive of oxygen of the recovered catalyst was P_{1.6}Mo₁₂Sb_{0.8}Cu_{0.1}V_{0.8}Cs₁. In 400 parts of pure water, 100 parts of the spent catalyst was dispersed. To the resultant dispersion, 130 parts of 45 mass % sodium hydroxide aqueous solution was added and stirred for 3 hours at 60° C. and its residue was removed by filtration. The pH of the resultant solution was 12.1. This solution was treated in the same manner as in the recovery of molybdenum 1 of Example 1 and recovered molybdenum-containing liquid was obtained. Further, recovered molybdenum-containing precipitate (recovered molybdenum-containing material 2) was obtained in the same manner as in the recovery of molybdenum 1 of Example 1. The recovered molybdenum-containing material 2 contained 53.5 parts of molybdenum, 1.8 parts of vanadium and 2.6 parts of cesium. And, at this time, rate of recovery of molybdenum was 97.1% by mass. Furthermore, phosphorus, antimony and copper were not detected in the recovered molybdenum-containing material 2.

(Production of Catalyst 2)

The total amount of the recovered molybdenum-containing material 2 obtained above (53.5 parts as molybdenum) was dispersed in 270 parts of pure water and 28.1 parts of 29 mass % aqueous ammonia was added to it and the material was dissolved at 60° C. In the resultant solution, 0.2 part of ammonium metavanadate and 5.2 parts of cesium nitrate were dissolved. Then, a solution obtained by dissolving 8.6 parts of 85 mass % phosphoric acid in 10 parts of pure water was added, and further, 5.4 parts of antimony trioxide was added and the resultant solution was heated to 95° C. with stirring, and a solution obtained by dissolving 1.1 parts of copper nitrate in 10 parts of pure water was added. The amount of ammonia in the resultant solution was 11.1 moles per 12 moles of molybdenum. Further, the mixed liquid thus obtained was stirred for 15 minutes at 95° C., and then, evaporated to dryness with stirring under heating. The solid material thus obtained was dried, molded, crushed, fractionated by sieves and calcined in the same manner as in the production of catalyst A for use in producing methacrylic acid of Reference Example 1 to obtain catalyst 2. The composition exclusive of oxygen of the catalyst 2 was P_{1.6}Mo₁₂Sb_{0.8}Cu_{0.1}V_{0.8}Cs₁.

(Test 2 of the Production of Methacrylic Acid)

By using this catalyst 2, reaction was carried out in the same reaction condition as that in the test A of the production of methacrylic acid and obtained the following results. Conversion of methacrolein was 83.1 mol %, selectivity to methacrylic acid was 83.5 mol % and per pass yield of methacrylic acid was 69.4 mol %, and the catalyst 2 had the same performance as the catalyst A.

### Reference Example 2

(Production of Catalyst B for Use in Producing Methacrylic Acid)

In 200 parts of pure water, 100 parts of ammonium paramolybdate was dissolved at 70° C. To the resultant solution, a solution obtained by dissolving 2.8 parts of ammonium metavanadate and 8.2 parts of 85 mass % phosphoric acid in 30 parts of pure water, a solution obtained by dissolving 1.1 parts of copper nitrate in 30 parts of pure water and a solution obtained by dissolving 3.8 parts of iron nitrate in 10 parts of pure water were added in this order, and the resultant solution was heated to 90° C. with stirring and kept at 90° C. for 5 hours with stirring, and a solution obtained by dissolving 9.2 parts of cesium nitrate in 100 parts of pure water was further added and the resultant liquid was evaporated to dryness with stirring under heating. The solid material thus obtained was dried, molded, crushed, fractionated by sieves and calcined in the same manner as in the production of catalyst A of Reference Example 1 to obtain catalyst B (the composition exclusive of oxygen of the catalyst B: P_{1.5}Mo₁₂Fe_{0.2}Cu_{0.1}V_{0.5}Cs₁).

(Test B of the Production of Methacrylic Acid)

By using this catalyst B, reaction was carried out in the same reaction condition as that in the test A of the production of methacrylic acid and obtained the following results. Conversion of methacrolein was 82.4 mol %, selectivity to methacrylic acid was 81.3 mol % and per pass yield of methacrylic acid was 67.0 mol %.

### Example 3

(Recovery of Molybdenum 3)

In 100 parts of the spent catalyst which had been used in the reaction for 2,000 hours in the test B of the production of methacrylic acid of Reference Example 2, 54.6 parts of molybdenum, 2.2 parts of phosphorus, 1.2 parts of vanadium, 0.3 part of copper, 0.5 part of iron and 6.3 parts of cesium were contained. The elemental composition exclusive of oxygen of the recovered catalyst was P_{1.5}Mo₁₂Fe_{0.2}Cu_{0.1}V_{0.5}Cs₁. In 400 parts of pure water, 100 parts of the spent catalyst was dispersed. To the resultant dispersion, 130 parts of 45 mass % sodium hydroxide aqueous solution was added and stirred for 3 hours at 60° C. and its residue was removed by filtration. The pH of the resultant solution was 12.3. This solution was treated in the same manner as in the recovery of molybdenum 1 of Example 1 and recovered molybdenum-containing liquid was obtained. Further, recovered molybdenum-containing precipitate (recovered molybdenum-containing material 3) was obtained in the same manner as in the recovery of molybdenum 1 of Example 1. The recovered molybdenum-containing material 3 contained 53.1 parts of molybdenum, 1.1 parts of vanadium and 2.6 parts of cesium. And, at this time, ratio of recovery of molybdenum was 97.3% by mass. Furthermore, phosphorus, iron and copper were not detected in the recovered molybdenum-containing material 3.

(Production of Catalyst 3)

The total amount of the recovered molybdenum-containing material 3 obtained above (53.1 parts as molybdenum) was dispersed in 180 parts of pure water and 27.8 parts of 29 mass % aqueous ammonia was added to it and the material was dissolved at 60° C. To the resultant solution, a solution obtained by dissolving 0.2 part of ammonium metavanadate and 8.0 parts of 85 mass % phosphoric acid in 30 parts of pure water, a solution obtained by dissolving 1.1 parts of copper nitrate in 30 parts of pure water and a solution obtained by dissolving 3.7 parts of iron nitrate in 10 parts of pure water were added in this order, and the resultant solution was heated to 90° C. with stirring and kept at 90° C. for 5 hours with stirring, and a solution obtained by dissolving 5.1 parts of cesium nitrate in 57 parts of pure water was further added. The amount of ammonia in the resultant solution was 10.8 moles per 12 moles of molybdenum. Further, the mixed liquid was evaporated to dryness with stirring under heating. The solid material thus obtained was dried, molded, crushed, fractionated by sieves and calcined in the same manner as in the production of catalyst B of Reference Example 2 to obtain catalyst 3. The composition exclusive of oxygen of the catalyst 3 was P_{1.5}Mo₁₂Fe_{0.2}Cu_{0.1}V_{0.5}Cs₁.

(Test 3 of the Production of Methacrylic Acid)

By using this catalyst 3, reaction was carried out in the same reaction condition as that in the test B of the production of methacrylic acid of Reference Example 2 and obtained the following results. Conversion of methacrolein was 82.6 mol %, selectivity to methacrylic acid was 81.2 mol % and per pass yield of methacrylic acid was 67.1 mol %, and the catalyst 3 had the same performance as the catalyst B.

### Reference Example 3

(Production of Catalyst C for Use in Producing Methacrylic Acid)

To 400 parts of pure water, 100 parts of molybdenum trioxide, 7.3 parts of 85 mass % phosphoric acid, 4.7 parts of vanadium pentoxide, 0.9 part of copper oxide and 0.2 part of iron oxide were added and stirred for 5 hours under refluxing. The resultant mixed liquid was cooled to 50° C. and 37.4 parts of 29 mass % aqueous ammonia was added to it by dropping and the resultant solution was stirred for 15 minutes. Then, a solution obtained by dissolving 9.0 parts of cesium nitrate in 30 parts of pure water was added to it by dropping and the resultant liquid was stirred for 15 minutes and evaporated to dryness with stirring under heating. The solid material thus obtained was dried, molded, crushed, fractionated by sieves and calcined in the same manner as in the production of catalyst A of Reference Example 1 to obtain catalyst C (the composition exclusive of oxygen of the catalyst C: P_{1.1}Mo₁₂Fe_{0.05}Cu_{0.2}V_{0.9}Cs_{0.8}).

(Test C of the Production of Methacrylic Acid)

By using this catalyst C, reaction was carried out in the same reaction condition as that in the test A of the production of methacrylic acid of Reference Example 1 and obtained the following results. Conversion of methacrolein was 87.4 mol %, selectivity to methacrylic acid was 85.8 mol % and per pass yield of methacrylic acid was 75.0 mol %.

### Example 4

(Recovery of Molybdenum 4)

In 100 parts of the spent catalyst which had been used in the reaction for 2,000 hours in the test C of the production of methacrylic acid of Reference Example 3, 55.2 parts of molybdenum, 1.6 parts of phosphorus, 2.2 parts of vanadium, 0.6 part of copper, 0.1 part of iron and 5.1 parts of cesium were contained. The elemental composition exclusive of oxygen of the recovered spent catalyst was P_{1.1}Mo₁₂Fe_{0.05}Cu_{0.2}V_{0.9}Cs_{0.8}. In 400 parts of pure water, 100 parts of the spent catalyst was dispersed. To the resultant dispersion, 130 parts of 45 mass % sodium hydroxide aqueous solution was added and stirred for 3 hours at 60° C. and its residue was removed by filtration. The pH of the resultant solution was 12.4. This solution was treated in the same manner as in the recovery of molybdenum 1 of Example 1 and recovered molybdenum-containing liquid was obtained. Further, recovered molybdenum-containing precipitate was isolated in the same manner as in the recovery of molybdenum 1 of Example 1 and dried at 110° C. for 16 hours. The dried material thus obtained was calcined at 550° C. for 3 hours and “recovered molybdenum-containing material 4” was obtained. The recovered molybdenum-containing material 4 contained 53.9 parts of molybdenum, 2.0 parts of vanadium and 2.5 parts of cesium. And, at this time, ratio of recovery of molybdenum was 97.7% by mass. Furthermore, phosphorus, iron and copper were not detected in the recovered molybdenum-containing material 4.

(Production of Catalyst 4)

To 320 parts of pure water, the total amount of the recovered molybdenum-containing material 4 obtained above (53.9 parts as molybdenum), 5.9 parts of 85 mass % phosphoric acid, 0.3 part of vanadium pentoxide, 0.7 part of copper oxide and 0.2 part of iron oxide were added and stirred for 5 hours under refluxing. The resultant mixed liquid was cooled to 50° C. and 30.2 parts of 29 mass % aqueous ammonia was added to it by dropping and the resultant solution was stirred for 15 minutes. Then, a solution obtained by dissolving 3.7 parts of cesium nitrate in 13 parts of pure water was added to it by dropping. The amount of ammonia in the resultant solution was 11.0 moles per 12 moles of molybdenum. Further, the resultant liquid was stirred for 15 minutes and evaporated to dryness with stirring under heating. The solid material thus obtained was dried, molded, crushed, fractionated by sieves and calcined in the same manner as in the production of catalyst C of Reference Example 3 to obtain catalyst 4. The composition exclusive of oxygen of the catalyst 4 was P_{1.1}Mo₁₂Fe_{0.05}Cu_{0.2}V_{0.9}CS_{0.8}.

(Test 4 of the Production of Methacrylic Acid)

By using the catalyst 4, reaction was carried out in the same reaction condition as that in the test C of the production of methacrylic acid of Reference Example 3 and obtained the following results. Conversion of methacrolein was 87.6 mol %, selectivity to methacrylic acid was 85.5 mol % and per pass yield of methacrylic acid was 74.9 mol %, and the catalyst 4 had the same performance as the catalyst C.

### Reference Example 4

(Production of Catalyst D for Use in Producing Methacrylic Acid)

To 800 parts of pure water, 100 parts of molybdenum trioxide, 2.6 parts of vanadium pentoxide and 6.7 parts of 85 mass % phosphoric acid were added and the resultant solution was heated and stirred for 3 hours under refluxing. To the resultant solution, 1.4 parts of copper oxide was added and further heated and stirred for 2 hours under refluxing. The resultant mixed liquid after refluxing was cooled to 50° C. and a solution obtained by dissolving 7.1 parts of potassium nitrate in 40 parts of pure water was added and a solution obtained by dissolving 9.8 parts of ammonium nitrate in 40 parts of pure water was further added, and the resultant liquid was evaporated to dryness with stirring under heating. The solid material thus obtained was dried, molded, crushed, fractionated by sieves and calcined in the same manner as in the production of catalyst A of Reference Example 1 to obtain catalyst D (the composition exclusive of oxygen of the catalyst D: P₁Mo₁₂Cu_{0.3}V_{0.5}K_{1.2}).

(Test D of the Production of Methacrylic Acid)

By using this catalyst D, reaction was carried out in the same reaction condition as that in the test A of the production of methacrylic acid of Reference Example 1 except that the reaction temperature was 285° C., and obtained the following results. Conversion of methacrolein was 85.0 mol %, selectivity to methacrylic acid was 84.2 mol % and per pass yield of methacrylic acid was 71.6 mol %.

### Example 5

(Recovery of Molybdenum 5)

In 100 parts of the spent catalyst which had been used in the reaction for 2,000 hours in the test D of the production of methacrylic acid of Reference Example 4, 57.6 parts of molybdenum, 1.6 parts of phosphorus, 1.3 parts of vanadium, 1.0 part of copper and 2.4 parts of potassium were contained. The elemental composition exclusive of oxygen of the recovered spent catalyst was P₁Mo₁₂Cu_{0.3}V_{0.5}K_{1.2}. In 400 parts of pure water, 100 parts of the spent catalyst was dispersed. To the resultant dispersion, 130 parts of 45 mass % sodium hydroxide aqueous solution was added and stirred for 3 hours at 60° C. and its residue was removed by filtration. The pH of the resultant solution was 12.4. This solution was treated in the same manner as in the recovery of molybdenum 1 of Example 1 and recovered molybdenum-containing liquid was obtained. Further, recovered molybdenum-containing precipitate was isolated in the same manner as in the recovery of molybdenum 1 of Example 1 and dried at 110° C. for 16 hours. The dried material thus obtained was calcined at 550° C. for 3 hours and “recovered molybdenum-containing material 5” was obtained. The recovered molybdenum-containing material 5 contained 55.9 parts of molybdenum, 1.1 parts of vanadium and 0.6 part of potassium. And, at this time, ratio of recovery of molybdenum was 97.1% by mass. Furthermore, phosphorus and copper were not detected in the recovered molybdenum-containing material 5.

(Production of Catalyst 5)

To 660 parts of pure water, the total amount of the recovered molybdenum-containing material 5 obtained above (55.9 parts as molybdenum), 0.2 part of vanadium pentoxide and 5.6 parts of 85 mass % phosphoric acid were added and the resultant solution was heated and stirred for 3 hours under refluxing. To the resultant solution, 1.2 parts of copper oxide was added and the resultant mixed liquid was further heated and stirred for 2 hours under refluxing. The resultant mixed liquid after refluxing was cooled to 50° C. and a solution obtained by dissolving 4.4 parts of potassium nitrate in 26 parts of pure water was added and a solution obtained by dissolving 8.1 parts of ammonium nitrate in 35 parts of pure water was further added. The amount of ammonia in the resultant solution was 2.1 moles per 12 moles of molybdenum. Further, the resultant mixed liquid was evaporated to dryness with stirring under heating. The solid material thus obtained was dried, molded, crushed, fractionated by sieves and calcined in the same manner as in the production of catalyst D of Reference Example 4 to obtain catalyst 5. The composition exclusive of oxygen of the catalyst 5 was P₁Mo₁₂Cu_{0.3}V_{0.5}K_{1.2}.

(Test 5 of the Production of Methacrylic Acid)

By using this catalyst 5, reaction was carried out in the same reaction condition as that in the test D of the production of methacrylic acid of Reference Example 4 and obtained the following results. Conversion of methacrolein was 85.3 mol %, selectivity to methacrylic acid was 84.1 mol % and per pass yield of methacrylic acid was 71.7 mol %, and the catalyst 5 had the same performance as the catalyst D.

### Reference Example 5

(Production of Catalyst E for Use in Producing Methacrylic Acid)

In 400 parts of pure water, 100 parts of ammonium paramolybdate, 4.4 parts of ammonium metavanadate and 4.8 parts of potassium nitrate were dissolved at 70° C. To the resultant solution under stirring, a solution obtained by dissolving 8.2 parts of 85 mass % phosphorus acid in 10 parts of pure water was added and a solution obtained by dissolving 1.1 parts of copper nitrate in 10 parts of pure water was further added. Then, to the resultant mixed liquid mentioned above, a homogeneous solution of bismuth nitrate obtained by adding 7.0 parts of 60 mass % nitric acid and 40 parts of pure water to 6.9 parts of bismuth nitrate was added and heated to 95° C. To the resultant liquid, a solution obtained by dissolving 2.2 parts of 60 mass % arsenic acid in 10 parts of pure water was added and 2.1 parts of antimony trioxide and 1.6 parts of cerium dioxide were subsequently added. The aqueous slurry thus obtained was evaporated to dryness with stirring under heating. The solid material thus obtained was dried, molded, crushed, fractionated by sieves and calcined in the same manner as in the production of catalyst A of Reference Example 1 to obtain catalyst E (the composition exclusive of oxygen of the catalyst E: P_{1.5}As_{0.2}Mo₁₂Sb_{0.3}Bi_{0.3}Ce_{0.2}Cu_{0.1}V_{0.8}K₁).

(Test E of the Production of Methacrylic Acid)

By using this catalyst E, reaction was carried out in the same reaction condition as that in the test A of the production of methacrylic acid of Reference Example 1 and obtained the following results. Conversion of methacrolein was 90.0 mol %, selectivity to methacrylic acid was 88.2 mol % and per pass yield of methacrylic acid was 79.4 mol %.

### Example 6

(Recovery of Molybdenum 6)

In 100 parts of the spent catalyst which had been used in the reaction for 2,000 hours in the test E of the production of methacrylic acid of Reference Example 5, 55.7 parts of molybdenum, 2.3 parts of phosphorus, 0.7 part of arsenic, 1.8 parts of antimony, 3.0 parts of bismuth, 1.4 parts of cerium, 0.3 part of copper, 2.0 parts of vanadium and 1.9 parts of potassium were contained. The elemental composition exclusive of oxygen of the recovered spent catalyst was P_{1.5}As_{0.2}Mo₁₂Sb_{0.3}Bi_{0.3}Ce_{0.2}Cu_{0.1}V_{0.8}K₁. In 400 parts of pure water, 100 parts of the spent catalyst was dispersed. To the resultant dispersion, 130 parts of 45 mass % sodium hydroxide aqueous solution was added and stirred and kept for 3 hours at 60° C. The pH of the resultant solution was 12.2. This solution was treated in the same manner as in the recovery of molybdenum 1 of Example 1 and recovered molybdenum-containing liquid was obtained. To the recovered molybdenum-containing liquid thus obtained, 36 mass % hydrochloric acid was added and pH of the resultant solution was adjusted to 6.0, and the resultant solution was passed through a column of weak basic ion-exchange resin (trade name “XE-583” manufactured by ORGANO CORPORATION). The solution after treatment by the ion-exchange resin was treated in the same manner as in the recovery of molybdenum 1 of Example 1 and recovered molybdenum-containing precipitate (recovered molybdenum-containing material 6) was obtained. The recovered molybdenum-containing material 6 contained 53.6 parts of molybdenum and 0.5 part of potassium. And, at this time, ratio of recovery of molybdenum was 96.2% by mass. Furthermore, phosphorus, arsenic, antimony, bismuth, cerium, copper and vanadium were not detected in the recovered molybdenum-containing material 6.

(Production of Catalyst 6)

To 650 parts of pure water, the total amount of the recovered molybdenum-containing material 6 obtained above (53.6 parts as molybdenum), 2.1 parts of vanadium pentoxide and 5.5 parts of 85 mass % phosphoric acid were added, and heated and stirred for 3 hours under refluxing. To the resultant solution, 1.1 parts of copper oxide was added and the resultant mixed liquid was further heated and stirred for 2 hours under refluxing. The mixed liquid after refluxing was cooled to 50° C. and a solution obtained by dissolving 4.6 parts of potassium nitrate in 26 parts of pure water was added and a solution obtained by dissolving 8.0 parts of ammonium nitrate in 35 parts of pure water was further added. The amount of ammonia in the resultant solution was 2.1 moles per 12 moles of molybdenum. Further, the resultant mixed liquid was evaporated to dryness with stirring under heating. The solid material thus obtained was dried, molded, crushed, fractionated by sieves and calcined in the same manner as in the production of catalyst D of Reference Example 4 to obtain catalyst 6. The composition exclusive of oxygen of the catalyst 6 was P₁Mo₁₂Cu_{0.3}V_{0.5}K_{1.2}.

(Test 6 of the Production of Methacrylic Acid)

By using this catalyst 6, reaction was carried out in the same reaction condition as that in the test D of the production of methacrylic acid of Reference Example 4 and obtained the following results. Conversion of methacrolein was 85.2 mol %, selectivity to methacrylic acid was 84.0 mol % and per pass yield of methacrylic acid was 71.6 mol %, and the catalyst 6 had the same performance as the catalyst D.

### Reference Example 6

(Production of Catalyst F for Use in Producing Methacrylic Acid)

To 800 parts of pure water, 100 parts of molybdenum trioxide, 3.2 parts of vanadium pentoxide and 8.7 parts of 85 mass % phosphoric acid were added and the resultant solution was heated and stirred for 3 hours under refluxing. To the resultant solution, 1.4 parts of copper nitrate was added and the resultant solution was further heated and stirred for 2 hours under refluxing. The mixed liquid after refluxing was cooled to 60° C. and a solution obtained by dissolving 12.3 parts of cesium bicarbonate in 30 parts of pure water was added and stirred for 15 minutes. Then, to the resultant solution, a solution obtained by dissolving 10 parts of ammonium nitrate in 30 parts of pure water was added and further stirred for 15 minutes, and the resultant solution was evaporated to dryness with stirring under heating. The solid material thus obtained was dried, molded, crushed, fractionated by sieves in the same manner as in the production of catalyst A of Reference Example 1 and calcined for 5 hours at 400° C. under a flow of nitrogen to obtain catalyst F (the composition exclusive of oxygen of the catalyst F: P_{1.3}Mo₁₂Cu_{0.1}V_{0.6}CS_{1.1}).

(Test F of the Production of Methacrylic Acid)

By using this catalyst F, reaction was carried out in the same reaction condition as that in the test A of the production of methacrylic acid of Reference Example 1 and obtained the following results. Conversion of methacrolein was 83.4 mol %, selectivity to methacrylic acid was 84.9 mol % and per pass yield of methacrylic acid was 70.8 mol %.

### Example 7

(Recovery of Molybdenum 7)

In 100 parts of the spent catalyst which had been used in the reaction for 2,000 hours in the test F of the production of methacrylic acid of Reference Example 6, 55.9 parts of molybdenum, 2.0 parts of phosphorus, 1.5 parts of vanadium, 0.3 part of copper and 7.1 parts of cesium were contained. The elemental composition exclusive of oxygen of the recovered catalyst was P_{1.3}Mo₁₂Cu_{0.1}V_{0.6}Cs_{1.1}. In 400 parts of pure water, 100 parts of the spent catalyst was dispersed. To the resultant dispersion, 25.7 parts of sodium hypochlorite (effective chlorine: 12 mass %) was added and stirred for 3 hours at 60° C., and 130 parts of 45 mass % sodium hydroxide aqueous solution was added and further stirred for 3 hours at 60° C. and its residue was removed by filtration. The pH of the resultant solution was 12.4. This solution was treated in the same manner as in the recovery of molybdenum 1 of Example 1 and recovered molybdenum-containing liquid was obtained. Further, recovered molybdenum-containing precipitate was isolated in the same manner as in the recovery of molybdenum 1 of Example 1 and dried at 110° C. for 16 hours. The dried material thus obtained was calcined at 550° C. for 3 hours and “recovered molybdenum-containing material 7” was obtained. The recovered molybdenum-containing material 7 contained 54.1 parts of molybdenum, 1.2 parts of vanadium and 2.9 parts of cesium. And, at this time, ratio of recovery of molybdenum was 96.8% by mass. Furthermore, phosphorus and copper were not detected in the recovered molybdenum-containing material 7.

(Production of Catalyst 7)

To 650 parts of pure water, the total amount of the recovered molybdenum-containing material 7 obtained above (54.1 parts as molybdenum), 0.9 part of vanadium pentoxide and 7.0 parts of 85 mass % phosphoric acid were added and the resultant solution was heated and stirred for 3 hours under refluxing. To the resultant solution, 0.9 part of copper nitrate was added and the resultant solution was further heated and stirred for 2 hours under refluxing. The mixed liquid after refluxing was cooled to 60° C. and a solution obtained by dissolving 5.7 parts of cesium bicarbonate in 14 parts of pure water was added and stirred for 15 minutes. Then, to the resultant solution, a solution obtained by dissolving 8.1 parts of ammonium nitrate in 24.4 parts of pure water was added. The amount of ammonia in the resultant solution was 2.2 moles per 12 moles of molybdenum. Further, the resultant mixed liquid was stirred for 15 minutes and evaporated to dryness with stirring under heating. The solid material thus obtained was dried, molded, crushed, fractionated by sieves and calcined in the same manner as in the production of catalyst F of Reference Example 6 to obtain catalyst 7. The composition exclusive of oxygen of the catalyst 7 was P_{1.3}Mo₁₂Cu_{0.1}V_{0.6}Cs_{1.1}.

(Test 7 of the Production of Methacrylic Acid)

By using this catalyst 7, reaction was carried out in the same reaction condition as that in the test F of the production of methacrylic acid of Reference Example 6 and obtained the following results. Conversion of methacrolein was 83.6 mol %, selectivity to methacrylic acid was 84.5 mol % and per pass yield of methacrylic acid was 70.6 mol %, and the catalyst 7 had the same performance as the catalyst F.

### Reference Example 7

(Production of Catalyst G for Use in Producing Methacrylic Acid)

In 300 parts of pure water, 100 parts of ammonium paramolybdate, 1.7 parts of ammonium metavanadate and 4.8 parts of potassium nitrate were dissolved at 70° C. To the resultant solution, a solution obtained by dissolving 8.2 parts of 85 mass % phosphorus acid in 10 parts of pure water was added and 4.1 parts of antimony trioxide was added and the resultant liquid was heated to 95° C. with stirring, and a solution obtained by dissolving 1.1 parts of copper nitrate in 30 parts of pure water was further added. Subsequently, to the resultant liquid, 4.5 parts of 20 mass % nitric acid was added. The resultant mixed liquid was evaporated to dryness with stirring under heating. The solid material thus obtained was dried, molded, crushed, fractionated by sieves and calcined in the same manner as in the production of catalyst A of Reference Example 1 to obtain catalyst G (the composition exclusive of oxygen of the catalyst G: P_{1.5}Mo₁₂Sb_{0.6}Cu_{0.1}V_{0.3}K₁).

(Test G of the Production of Methacrylic Acid)

By using this catalyst G, reaction was carried out in the same reaction condition as that in the test A of the production of methacrylic acid of Reference Example 1 except that the reaction temperature was 280° C., and obtained the following results. Conversion of methacrolein was 80.2 mol %, selectivity to methacrylic acid was 82.3 mol % and per pass yield of methacrylic acid was 66.0 mol %.

(Recovery of Molybdenum 8)

In 100 parts of the spent catalyst which had been used in the reaction for 2,000 hours in the test G of the production of methacrylic acid of Reference Example 7, 55.9 parts of molybdenum, 2.3 parts of phosphorus, 0.7 part of vanadium, 0.3 part of copper, 3.5 parts of antimony and 1.9 parts of potassium were contained. The elemental composition exclusive of oxygen of the recovered catalyst was P_{1.5}Mo₁₂Sb_{0.6}Cu_{0.1}V_{0.3}K₁. In 400 parts of pure water, 100 parts of the spent catalyst was dispersed. To the resultant dispersion, 130 parts of 45 mass % sodium hydroxide aqueous solution was added and stirred for 3 hours at 60° C. and its residue was removed by filtration. The pH of the resultant solution was 12.1. This solution was treated in the same manner as in the recovery of molybdenum 1 of Example 1 and recovered molybdenum-containing liquid was obtained. Further, recovered molybdenum-containing precipitate (recovered molybdenum-containing material 8) was obtained in the same manner as in the recovery of molybdenum 1 of Example 1. The recovered molybdenum-containing material 8 contained 54.5 parts of molybdenum, 0.6 part of vanadium and 0.5 part of potassium. And, at this time, ratio of recovery of molybdenum was 97.5% by mass. Furthermore, phosphorus, antimony and copper were not detected in the recovered molybdenum-containing material 8.

(Production of Catalyst 8)

The total amount of the recovered molybdenum-containing material 8 obtained above (54.5 parts as molybdenum) was dispersed in 270 parts of pure water and 28.6 parts of 29 mass % aqueous ammonia was added to it and the material was dissolved at 60° C. In the resultant solution, 0.3 part of ammonium metavanadate and 3.6 parts of potassium nitrate were dissolved. Then, a solution obtained by dissolving 8.2 parts of 85 mass % phosphoric acid in 10 parts of pure water was added, and further, 4.1 parts of antimony trioxide was added and the resultant solution was heated to 95° C. with stirring, and a solution obtained by dissolving 1.1 parts of copper nitrate in 30 parts of pure water was added, and then 4.5 parts of 20 mass % nitric acid was added. The amount of ammonia in the resultant solution was 10.6 moles per 12 moles of molybdenum. Further, the mixed liquid thus obtained was evaporated to dryness with stirring under heating. The solid material thus obtained was dried, molded, crushed, fractionated by sieves and calcined in the same manner as in the production of catalyst A of Reference Example 1 to obtain catalyst 7. The composition exclusive of oxygen of the catalyst 8 was P_{1.5}Mo₁₂Sb_{0.6}Cu_{0.1}V_{0.3}K₁.

(Test 8 of the Production of Methacrylic Acid)

By using this catalyst 8, reaction was carried out in the same reaction condition as that in the test G of the production of methacrylic acid of Reference Example 7 and obtained the following results. Conversion of methacrolein was 80.1 mol %, selectivity to methacrylic acid was 82.5 mol % and per pass yield of methacrylic acid was 66.1 mol %, and the catalyst 8 had the same performance as the catalyst G.

### Reference Example 8

(Production of Catalyst H for Use in Producing Methacrylic Acid)

To 200 parts of pure water, 100 parts of molybdenum trioxide, 2.6 parts of vanadium pentoxide, 6.7 parts of 85 mass % phosphoric acid and 2.7 parts of 60 mass % arsenic acid were added and the resulting solution was heated and stirred for 5 hours under refluxing. The resultant solution was cooled to 50° C. and a solution obtained by dissolving 13.5 parts of cesium nitrate in 30 parts of pure water was added, and the mixed liquid thus obtained was heated to 70° C. with stirring. Then, 34.0 parts of 29 mass % aqueous ammonia was added and the resultant mixed liquid was stirred for 90 minutes at 70° C. and a solution obtained by dissolving 2.8 parts of copper nitrate in 10 parts of pure water and a solution obtained by dissolving 1.2 parts of iron nitrate in 10 parts of pure water were further added, and the resultant liquid was evaporated to dryness with stirring under heating. The solid material thus obtained was dried, molded, crushed, fractionated by sieves and calcined in the same manner as in the production of catalyst A of Reference Example 1 to obtain catalyst H (the composition exclusive of oxygen of the catalyst H: P₁As_{0.2}Mo₁₂Fe_{0.05}Cu_{0.2}V_{0.5}Cs_{1.2}).

(Test H of the Production of Methacrylic Acid)

By using this catalyst H, reaction was carried out in the same reaction condition as that in the test A of the production of methacrylic acid of Reference Example 1 and obtained the following results. Conversion of methacrolein was 82.5 mol %, selectivity to methacrylic acid was 87.6 mol % and per pass yield of methacrylic acid was 72.3 mol %.

### Example 9

(Recovery of Molybdenum 9)

In 100 parts of the spent catalyst which had been used in the reaction for 2,000 hours in the test H of the production of methacrylic acid of Reference Example 8, 55.8 parts of molybdenum, 1.5 parts of phosphorus, 1.2 parts of vanadium, 0.6 part of copper, 0.1 part of iron, 0.7 part of arsenic and 7.7 parts of cesium were contained. The elemental composition exclusive of oxygen of the recovered spent catalyst was P₁As_{0.2}Mo₁₂Fe_{0.05}Cu_{0.2}V_{0.5}Cs_{1.2}. In 400 parts of pure water, 100 parts of the spent catalyst was dispersed. To the resultant dispersion, 130 parts of 45 mass % sodium hydroxide aqueous solution was added and stirred for 3 hours at 60° C. and its residue was removed by filtration. The pH of the resultant solution was 12.2. This solution was treated in the same manner as in the recovery of molybdenum 1 of Example 1 and recovered molybdenum-containing liquid was obtained. Further, recovered molybdenum-containing precipitate was isolated in the same manner as in the recovery of molybdenum 1 of Example 1 and dried at 110° C. for 16 hours. The dried material thus obtained was calcined at 550° C. for 3 hours and “recovered molybdenum-containing material 9” was obtained. The recovered molybdenum-containing material 9 contained 54.3 parts of molybdenum, 1.0 part of vanadium and 2.9 parts of cesium. And, at this time, ratio of recovery of molybdenum was 97.4% by mass. Furthermore, phosphorus, arsenic, iron and copper were not detected in the recovered molybdenum-containing material 9.

(Production of Catalyst 9)

To 160 parts of pure water, the total amount of the recovered molybdenum-containing material 9 obtained above (54.3 parts as molybdenum), 0.4 part of vanadium pentoxide, 5.4 parts of 85 mass % phosphoric acid and 2.2 parts of 60 mass % arsenic acid were added and the resultant solution was heated and stirred for 5 hours under refluxing. The resultant solution was cooled to 50° C. and a solution obtained by dissolving 6.7 parts of cesium nitrate in 15 parts of pure water was added, and the mixed liquid thus obtained was heated to 70° C. Then, 27.4 parts of 29 mass % aqueous ammonia was added and the resultant mixed liquid was stirred for 90 minutes at 70° C. and a solution obtained by dissolving 2.3 parts of copper nitrate in 8 parts of pure water and a solution obtained by dissolving 1.0 part of iron nitrate in 8 parts of pure water were further added. The amount of ammonia in the resultant solution was 9.9 moles per 12 moles of molybdenum. Further, the resultant mixed liquid was evaporated to dryness with stirring under heating. The solid material thus obtained was dried, molded, crushed, fractionated by sieves and calcined in the same manner as in the production of catalyst H of Reference Example 8 to obtain catalyst 9. The composition exclusive of oxygen of the catalyst 9 was P₁As_{0.2}Mo₁₂Fe_{0.05}Cu_{0.2}V_{0.5}Cs_{1.2}.

(Test 9 of the Production of Methacrylic Acid)

By using this catalyst 9, reaction was carried out in the same reaction condition as that in the test H of the production of methacrylic acid of Reference Example 8 and obtained the following results. Conversion of methacrolein was 82.7 mol %, selectivity to methacrylic acid was 87.4 mol % and per pass yield of methacrylic acid was 72.3 mol %, and the catalyst 9 had the same performance as the catalyst H.

### Example 10

(Production of Catalyst 10)

To 260 parts of pure water, the total amount of the recovered molybdenum-containing material obtained in the same manner as in recovery of molybdenum 9 of Example 9 (54.3 parts as molybdenum), 50 parts of molybdenum trioxide obtained by calcining ammonium paramolybdate at 550° C. for 3 hours, 1.7 part of vanadium pentoxide, 8.8 parts of 85 mass % phosphoric acid and 3.6 parts of 60 mass % arsenic acid were added and the resultant solution was heated and stirred for 5 hours under refluxing. The resultant solution was cooled to 50° C. and a solution obtained by dissolving 13.5 parts of cesium nitrate in 30 parts of pure water was added, and the mixed liquid thus obtained was heated to 70° C. Then, 44 parts of 29 mass % aqueous ammonia was added. The amount of ammonia in the resultant solution was 9.9 moles per 12 moles of molybdenum. The resultant mixed liquid was stirred at 70° C. for 90 minutes and a solution obtained by dissolving 3.7 parts of copper nitrate in 13 parts of pure water and a solution obtained by dissolving 1.6 parts of iron nitrate in 13 parts of pure water were added and the resultant mixed liquid was evaporated to dryness with stirring under heating. The solid material thus obtained was dried, molded, crushed, fractionated by sieves and calcined in the same manner as in the production of catalyst H of Reference Example 8 to obtain catalyst 10. The composition exclusive of oxygen of the catalyst 10 was P₁As_{0.2}Mo₁₂Fe_{0.05}Cu_{0.2}V_{0.5}Cs_{1.2}.

(Test 10 of the Production of Methacrylic Acid)

By using this catalyst 10, reaction was carried out in the same reaction condition as that in the test H of the production of methacrylic acid of Reference Example 8 and obtained the following results. Conversion of methacrolein was 82.9 mol %, selectivity to methacrylic acid was 87.3 mol % and per pass yield of methacrylic acid was 72.4 mol %, and the catalyst 10 had the same performance as the catalyst H.

### Comparative Example 1

(Recovery of Molybdenum 10)

The same manner as in the recovery of molybdenum 1 of Example 1 was carried out except that pH of the liquid after adding 45 mass % sodium hydroxide aqueous solution and stirring was adjusted to 4 by 36 mass % hydrochloric acid and pH of the liquid after adding magnesium chloride hexahydrate solution and 29 mass % aqueous ammonia was adjusted to 5 by 29 mass % aqueous ammonia, and thus “recovered molybdenum-containing material 10” was obtained. The recovered molybdenum-containing material 10 contained 21.4 parts of molybdenum, and 0.6 part of phosphorus. At this time, ratio of recovery of molybdenum was 38.2% by mass and the ratio of recovery was drastically lowered. Removal of phosphorus was insufficient in this method. Nevertheless, cesium was not detected in the recovered molybdenum-containing material 10.

### Comparative Example 2

(Recovery of Molybdenum 11)

The same manner as in the recovery of molybdenum 1 of Example 1 was carried out except that 36 mass % hydrochloric acid was not added after adding 45 mass % sodium hydroxide aqueous solution and stirring and 29 mass % aqueous ammonia was not added after adding magnesium chloride hexahydrate solution and 29 mass % aqueous ammonia, and thus “recovered molybdenum-containing material 11” was obtained. The recovered molybdenum-containing material 11 contained 54.3 parts of molybdenum, 1.5 parts of phosphorus and 5.9 parts of cesium. At this time, ratio of recovery of molybdenum was 96.4% by mass, however, removal of phosphorus was insufficient in this method.

### INDUSTRIAL APPLICABILITY

By the method for recovering molybdenum of the present invention, molybdenum can be recovered in high yield from a molybdenum-containing material comprising at least molybdenum, A element (phosphorus and/or arsenic) and X element (at least one selected from the group consisting of potassium, rubidium, cesium and thallium), and hence, a spent molybdenum-containing material, in particular, a spent catalyst can be used effectively. Further, by using the present invention, it is possible to produce a catalyst by using a recovered molybdenum-containing material which has been recovered from the molybdenum-containing material comprising at least molybdenum, A element and X element as a raw material for the catalyst, and hence, the molybdenum-containing material comprising at least molybdenum, A element and X element, in particular, a catalyst for use in producing methacrylic acid can be used effectively even after it has been spent.

1. A method for recovering molybdenum comprising the steps of:
1) dispersing a molybdenum-containing material which contains at least molybdenum, A element (phosphorus and/or arsenic) and X element (at least one selected from the group consisting of potassium, rubidium, cesium and thallium) in water and adding alkali to make pH of the resultant mixed liquid 8 or more;
2) adjusting pH of the resultant mixed liquid to fall within the range of from 6 to 12 followed by adding a compound containing magnesium and aqueous ammonia to form a precipitate containing at least magnesium and A element; and
3) separating the precipitate containing at least magnesium and A element formed in the step 2) from a solution containing at least molybdenum (recovered molybdenum-containing liquid).

2. The method for recovering molybdenum according to claim 1, further comprising the step of:
4) forming a precipitate containing at least molybdenum by adjusting the pH of the recovered molybdenum-containing liquid to 3 or less and separating the precipitate thus formed (recovered molybdenum-containing precipitate) from the solution.

3. The method for recovering molybdenum according to claim 1, wherein a molybdenum-containing material which contains at least molybdenum, A element (phosphorus and/or arsenic) and X element (at least one selected from the group consisting of potassium, rubidium, cesium and thallium) is a catalyst for use in producing methacrylic acid through gas-phase catalytic oxidation of methacrolein having a composition represented by the following formula (1):
AₐMo_{b}Y_{c}X_{d}Oₑ (1)
wherein Mo and O represent molybdenum and oxygen, respectively; A represents phosphorus and/or arsenic; Y represents at least one element selected from the group consisting of iron, cobalt, nickel, copper, zinc, magnesium, calcium, strontium, barium, titanium, vanadium, chromium, tungsten, manganese, silver, boron, silicon, aluminum, gallium, germanium, tin, lead, antimony, bismuth, niobium, tantalum, zirconium, indium, sulfur, selenium, tellurium, lanthanum and cerium; X represents at least one element selected from the group consisting of potassium, rubidium, cesium and thallium; and subscripts a, b, c, d, and e represent an atomic ratio of each element, respectively; when b is 12, a is in the range of from 0.1 to 3, c is in the range of from 0 to 3 and d is in the range of from 0.01 to 3 and e represents the atomic ratio of oxygen necessary for fulfilling the requirement of the valence of each element above.

4. A method for producing a catalyst by using a recovered molybdenum-containing liquid which has been recovered by the steps of:
1) dispersing a molybdenum-containing material which contains at least molybdenum, A element (phosphorus and/or arsenic) and X element (at least one selected from the group consisting of potassium, rubidium, cesium and thallium) in water and adding alkali to make pH of the resultant mixed liquid 8 or more;
2) adjusting pH of the resultant mixed liquid to fall within the range of from 6 to 12 followed by adding a compound containing magnesium and aqueous ammonia to form a precipitate containing at least magnesium and A element;
3) separating the precipitate containing at least magnesium and A element found in the step 2) from a solution containing at least molybdenum and/or
a recovered molybdenum-containing precipitate which has been obtained by the further step of:
4) forming a precipitate containing at least molybdenum by adjusting the pH of the recovered molybdenum-containing liquid to 3 or less and separating the precipitate thus formed from the recovered molybdenum-containing (liquid expressed altogether as “recovered molybdenum-containing material”).

5. The method for producing a catalyst according to claim 4, wherein the catalyst is produced by using a raw material of molybdenum other than the recovered molybdenum-containing material together with the recovered molybdenum-containing material.

6. The method for producing a catalyst according to claim 4, wherein 1 to 17 moles of ammonia per 12 atoms of molybdenum is included when the catalyst is produced.

7. The method for producing a catalyst according to claim 4, wherein temperature of solution or slurry in the entire steps or a part of the steps in the production of catalyst is 0 to 40° C. lower than that in the case where a raw material of molybdenum other than the recovered molybdenum-containing material is used.

8. The method for producing a catalyst according to claim 4, wherein the catalyst has a composition represented by the following formula (1):
AₐMo_{b}Y_{c}X_{d}Oₑ (1)
wherein Mo and O represent molybdenum and oxygen, respectively; A represents phosphorus and/or arsenic; Y represents at least one element selected from the group consisting of iron, cobalt, nickel, copper, zinc, magnesium, calcium, strontium, barium, titanium, vanadium, chromium, tungsten, manganese, silver, boron, silicon, aluminum, gallium, germanium, tin, lead, antimony, bismuth, niobium, tantalum, zirconium, indium, sulfur, selenium, tellurium, lanthanum and cerium; X represents at least one element selected from the group consisting of potassium, rubidium, cesium and thallium; and subscripts a, b, c, d, and e represent an atomic ratio of each element, respectively; when b is 12, a is in the range of from 0.1 to 3, c is in the range of from 0 to 3 and d is in the range of from 0.01 to 3 and e represents the atomic ratio of oxygen necessary for fulfilling the requirement of the valence of each element above.

9. The method for producing a catalyst according to claim 5, wherein 1 to 17 moles of ammonia per 12 atoms of molybdenum is included when the catalyst is produced.

10. The method for producing a catalyst according to claim 7, wherein the catalyst has a composition represented by the following formula (1):
AₐMo_{b}Y_{c}X_{d}Oₑ (1)
wherein Mo and O represent molybdenum and oxygen, respectively; A represents phosphorus and/or arsenic; Y represents at least one element selected from the group consisting of iron, cobalt, nickel, copper, zinc, magnesium, calcium, strontium, barium, titanium, vanadium, chromium, tungsten, manganese, silver, boron, silicon, aluminum, gallium, germanium, tin, lead, antimony, bismuth, niobium, tantalum, zirconium, indium, sulfur, selenium, tellurium, lanthanum and cerium; X represents at least one element selected from the group consisting of potassium, rubidium, cesium and thallium; and subscripts a, b, c, d, and e represent an atomic ratio of each element, respectively; when b is 12, a is in the range of from 0.1 to 3, c is in the range of from 0 to 3 and d is in the range of from 0.01 to 3 and e represents the atomic ratio of oxygen necessary for fulfilling the requirement of the valence of each element above.
